(19) United States
(12) Patent Application Publication
(10) Pub. No.: US 2005/0114371 A1
(43) Pub. Date: May 26, 2005

(54) System, method and computer program product for internet tool

(76) Inventor: Michael E. Woods, Tiburon, CA (US)

Correspondence Address: MICHAEL E. WOODS;PATENT LAW OFFICES OF MICHAEL E. WOODS, 112 BARN ROAD, TIBURON, CA, 94920-2602, US

(21) Appl. No.: 10/994,896

(22) Filed: Nov. 22, 2004

Related U.S. Application Data
(60) Provisional application No. 60/524,106, filed on Nov. 22, 2003.

(51) Int. Cl. G06F 7/00

(52) U.S. Cl. 707/100

(57) ABSTRACT

Disclosed is a method, apparatus and computer program product for improving navigation to queryable network processes. The apparatus for generating a query to a particular one of a plurality of queryable network processes, the apparatus including a query assembly system communicable to a network supporting the queryable network processes, the query assembly system having: a first memory; and first control logic, configured to produce, in response to a first set of instructions in the first memory and to an input from a user, the query to the particular one of the plurality of queryable network processes, the particular one query derived from a content of a data field according to a particular one of a plurality of concurrently displayed query actuating controls of an interface element actuated by the input, with each of the query actuating controls associated with a different one of the plurality of queryable network processes and the particular one queryable network process associated with the particular one query actuating control; and a query communications system, communicable to a network supporting the queryable network processes, the query communications system including: a second memory; and second control logic, configured to communicate, in response to a second set of instructions in the second memory and to production of the query by the query assembly system, the query to the particular one queryable network process. The method for generating a query to a particular one of a plurality of queryable network processes, the method including producing the query from a content of a user-enterable data field of an interface element in response to an actuation of one of a plurality of concurrently presented controls of the interface, each the control having an association with a different one of the plurality of queryable network processes; and communicating the query to the particular one queryable network process.

### CROSS-REFERENCE TO RELATED APPLICATIONS

This application claims benefit of U.S. Provisional Patent Application 60/524,106 filed 22 Nov. 2003 and entitled “SYSTEM, METHOD AND COMPUTER PROGRAM PRODUCT FOR INTERNET TOOL,” the disclosure of which is expressly incorporated by reference in its entirety for all purposes.

### BACKGROUND OF THE INVENTION

The present invention relates generally to network navigation and more specifically to Internet/Web navigation to desired resources.

It is well-known to provide network access applications (e.g., Internet browsers) to locate, navigate and access network resources. These applications typically require a user to enter a resource identifier (e.g., a universal resource locator or URL, a resource identified by name—universal naming convention (UNC) or directory/file system (DFS)).

These resources may be distributed widely across many locations, requiring the user to enter many diverse resource identifiers. Often these identifiers have long names and in many cases, machine-generated names that challenge the users to remember them. There are solutions that aid the user in remembering these names: bookmarks and search engines are common solutions.

Many access applications provide the user with an ability to store a desired identifier into a drop down list. Whenever the user wants to access a resource for which the user has stored the identifier, the user selects the stored identifier from a list. This is easy, provided that the user recognizes the resource from the stored identifier, and provided that the list of stored identifiers is not unduly long. Some access applications assist in management of stored identifiers by providing another directory/subdirectory structure that helps some users locate the particular identifier.

There are many search engines, some general purpose and some special purpose search engines, that users may use to locate particular resources. Due to the large amount of available resources, there are instances in which a resource, or the associated link, is fungible. A user looking for the content of a link and not specifically for a certain link is able to use the search engine solution and does not necessarily need to remember any single identifier.

One common resource type that is bookmarked by many users are local search functions. The identifier provides a resource that permits the user to enter desired parameters, initiate the search with the specified parameters, and obtain the results of the search. Many Internet search engines, that is, a search engine for multiple public domains, provide this search function to identify specific words on any of the multitudes of available web pages. Google Inc. (www.google.com) and Yahoo Inc. (www.yahoo.com) are two representative companies that provide this type of Internet search engine.

To assist users with their searches using a specific site, many of the search engines provide the user with a dedicated search toolbar for accessing the search engine. These toolbars typically have a data entry field for a search query, and an actuable button to access the designated search engine with the contents of the data entry field. The toolbar gives the user access to the specific toolbar associated search engine anytime that the toolbar is active, typically when the associated application is active.

To access multiple search systems, the prior art provides two solutions. One is to add multiple toolbars, one for each search system. The second is to provide a drop down list that reconfigures a particular association between the data entry field and one of a group of predefined search engines. One such product is Ultrabar® available from www.ultrabar.com (Ultrabar being a wholly owned subsidiary of VPOP Technologies, Inc., (www.vpop.net)).

This toolbar provides drop-down configuration to associate a particular search function with the single data entry field. In one configuration, the user selects a first search engine using a drop-down list of configured search engines. When the user actuates a different search initiation button, content of a data entry field is sent to the first search engine. When a second engine is selected from the drop down list, a search of the second engine is initiated with the content of the data entry field. In this way, functionality of several search-toolbars are added to a single toolbar, but the operation of the toolbar is the same after each configuration. Namely, actuation of the search initiation button submits the information into the designated search engine. Some of these toolbars provide the user with an ability to add custom search engines/locations to the toolbar.

Unfortunately, these solutions are cumbersome for efficiently accessing a range of information. When multiple sites are searched for different types of information, a user is continuously changing search engines. If there are more than a few options, the dropdown lists may become crowded and cryptic, decreasing the efficiency. Many users do not have the training and/or inclination to produce customized search engine entries to add their own searches. Thus, a user is limited to options provided to the user at the time of the installation of the toolbar.

What is needed is an efficient toolbar solution that provides a user with simple and quick searches across a plurality of locations, and one that may be expanded without complicated or time-consuming configuration options.

### BRIEF SUMMARY OF THE INVENTION

Disclosed is a method, apparatus and computer program product for improving navigation to queryable network processes. The apparatus for generating a query to a particular one of a plurality of queryable network processes, the apparatus including a query assembly system communicable to a network supporting the queryable network processes, the query assembly system having: a first memory; and first control logic, configured to produce, in response to a first set of instructions in the first memory and to an input from a user, the query to the particular one of the plurality of queryable network processes, the particular one query derived from a content of a data field according to a particular one of a plurality of concurrently displayed query actuating controls of an interface element actuated by the input, with each of the query actuating controls associated with a different one of the plurality of queryable network processes and the particular one queryable network process associated with the particular one query actuating control; and a query communications system, communicable to a network supporting the queryable network processes, the query communications system including: a second memory; and second control logic, configured to communicate, in response to a second set of instructions in the second memory and to production of the query by the query assembly system, the query to the particular one queryable network process. The method for generating a query to a particular one of a plurality of queryable network processes, the method including producing the query from a content of a user-enterable data field of an interface element in response to an actuation of one of a plurality of concurrently presented controls of the interface, each the control having an association with a different one of the plurality of queryable network processes; and communicating the query to the particular one queryable network process.

This method is also implemented by executing program instructions included in a computer program product including a computer readable medium carrying the program instructions for generating a query to a particular one of a plurality of queryable network processes when executed using a computing system. In some cases, a single control element actuates a heuristic analysis of a content of the data field and selects the appropriate queryable network process from the available querys, taking any defined themes into account.

The present invention is an efficient and simple solution to improving a user's ability to quickly and accurately produce resource access directives to a desired one or more queryable network processes, such as for example, generating search queries for desired information. Queries are grouped in desired collections, a collection being a theme, permitting the user to access the network processes as reference sources for targeted specific results. Users do not have to remember search locations, or learn how to configure/maintain limited search engines. In some implementations, queries associated with themes may be updated, manually or automatically simply without learning or implementing a limited macroing language.

### BRIEF DESCRIPTION OF THE DRAWINGS

FIG. 1 is a computer system 100 that may function as a basic computer in implementing the present invention for an efficient toolbar solution that provides a user with simple and quick searches across a plurality of locations, and one that may be expanded without complicated or time-consuming configuration options;

FIG. 2 is an illustration of a graphical user interface for a preferred embodiment of the present invention as a stand-alone applet; and

FIG. 3 is an illustration of a toolbar implementation of an alternate preferred embodiment of the present invention.

### DETAILED DESCRIPTION OF THE INVENTION

The present invention relates to an efficient toolbar solution that provides a user with simple and quick searches across a plurality of locations, and one that may be expanded without complicated or time-consuming configuration options. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

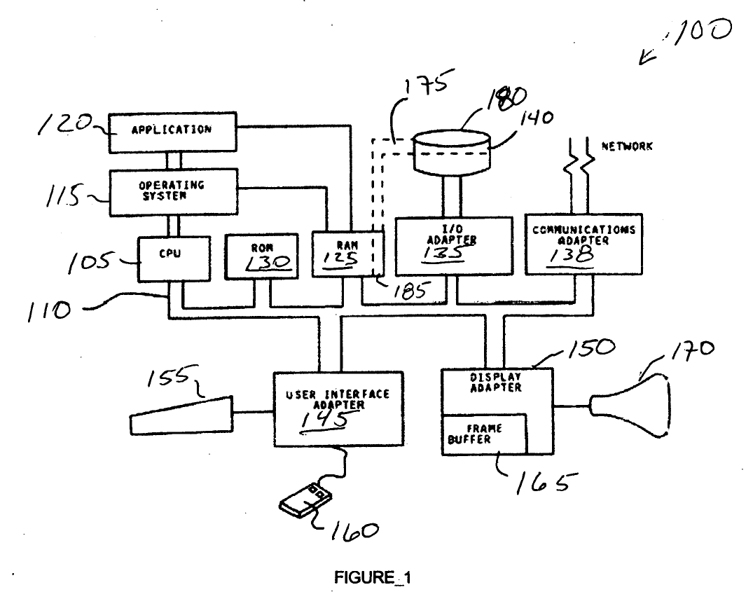

FIG. 1 is a computer system 100 that may function as a basic computer in implementing the present invention for an efficient toolbar solution that provides a user with simple and quick searches across a plurality of locations, and one that may be expanded without complicated or time-consuming configuration options. Computer system 100 includes a central processing unit (CPU) 105, such as one of the PC microprocessors or workstations, e.g. RISC System/6000 (RS/6000) (RISC System/6000 is a trademark of International Business Machines Corporation) series available from International Business Machines Corporation (IBM), is provided and interconnected to various other components by a system bus 110. An operating system 115 runs on CPU 105, provides control and is used to coordinate the function of the various components of FIG. 1. Operating system 115 may be one of the commercially available operating systems such as the AIX 6000 operating system or OS/2 operating system available from IBM (AIX 6000 and OS/2 are trademarks of IBM); Microsoft's Windows 98 or Windows NT, as well as UNIX and AIX operating systems. One or more application programs 120, controlled by the system, are moved into and out of a main memory RAM 125. These programs include the program of the present invention to be subsequently described in combination with local or wide-area network systems, such as for example, the Internet. A read only memory (ROM) 130 is connected to CPU 105 via bus 110 and includes the Basic Input/Output System (BIOS) that controls the basic computer functions. RAM 125, an I/O adapter 135 and a communications adapter 138 are also interconnected to system bus 110. I/O adapter 135 may be a Small Computer System Interface (SCSI) adapter that communicates with a disk storage device 140. Communications adapter 135 interconnects bus 110 with an outside network enabling the data processing system to communicate with other such systems over a Local Area Network (LAN) or Wide Area Network (WAN), which includes, of course, the Internet, the WEB, intranets, extranets, and other public and private networks. The terms associated with the network are meant to be generally interchangeable and are so used in the present description of the distribution network. I/O devices are also connected to system bus 110 via a user interface adapter 145 and a display adapter 150. A keyboard 155 and a pointing device (e.g., mouse 160) are all interconnected to bus 110 through user interface adapter 145. It is through such input devices that the user may interactively relate to the programs for an efficient toolbar solution that provides a user with simple and quick searches across a plurality of locations, and one that may be expanded without complicated or time-consuming configuration options according to the present invention. Display adapter 150 includes a frame buffer 165, which is a storage device that holds a representation of each pixel on a monitor or display screen 170. Images may be stored in frame buffer 165 for display on monitor 170 through various components, such as a digital to analog converter (not shown) and the like. By using the aforementioned I/O devices, a user is capable of inputting information to the system through the keyboard 155 or mouse 160 and receiving output information from the system via display 170. The system also contains a memory cache 175 which is illustrated as a dashed line outline and includes a portion 180 of a disk storage drive 140 and a portion 185 of RAM 125.

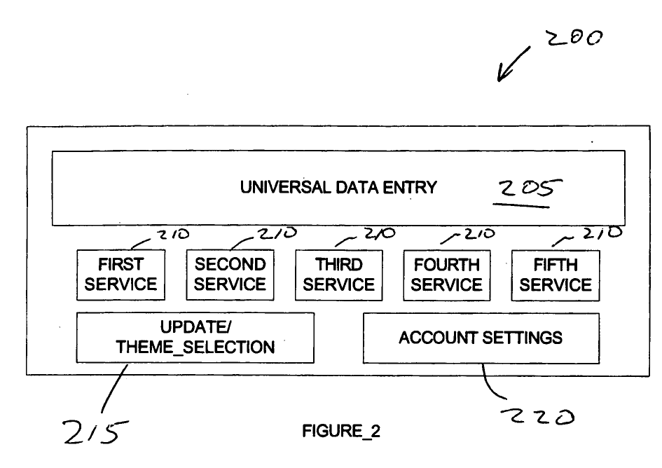

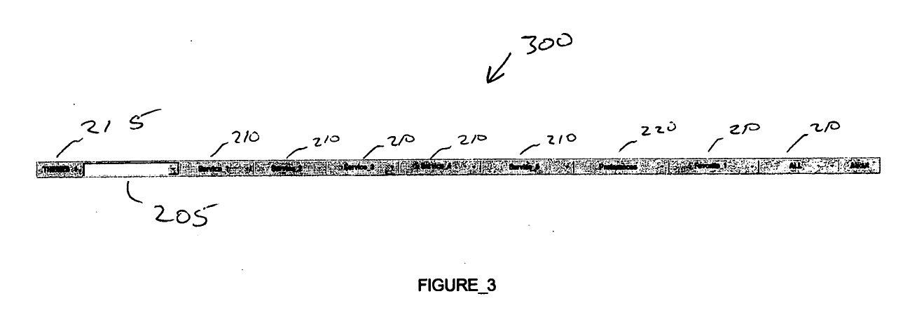

FIG. 2 is an illustration of a graphical user interface 200 for a preferred embodiment of the present invention as a stand-alone applet. FIG. 3 is an illustration of a toolbar 300 implementation of an alternate preferred embodiment of the present invention. Interface 200 and toolbar 300 both include a data input field 205, service actuation buttons 210, a theme/update button 215, and an account/preferences setting button 220. To simplify the following discussion, interface 200 will be understood to include both interface 200 shown in FIG. 2 and toolbar 300 shown in FIG. 3 unless expressly excepted or the context indicates otherwise.

Field 205 receives user input, typically a search query appropriate for a service function to be called. The user input is usually alpha-numeric, though other symbols, graphics or other elements may be accepted depending upon the particular implementation.

Service actuation buttons 210 are a plurality of interface elements that each initiate a different service process when selected. Each button 210 is concurrently presented with other buttons 210 and are independently actuable to direct the user input from field 205 to the identified service.

In the preferred embodiment, these services are typically search applets or databases that use the user input as all or part of a query or key to retrieval of information. For example, the United States Patent and Trademark Office maintains a website (www.uspto.gov) having several different webpages where a user may enter data to retrieve specific patent, patent application, trademark, trademark application, attorney, or general information. Buttons 210 may be assigned to each webpage, so that one button 210 will retrieve patent information when field 210 contains a patent number, another button will retrieve patent application information when field 205 contains a number for a patent application. Another button 210, linked to the USPTO's roster search, will return a list of registered attorneys and agents. The list has names associated to the user data in field 205 when this button was actuated.

Buttons 210 are not all limited to a single domain. Other services may include searches into databases for 35 U.S.C., 37 C.F.R., the Manual of Patent Examining Procedure (MPEP), an online (local or network) treatise, or other resource, each service potentially available from a wide variety of different domains.

In contrast to the prior art, interface 200 merges services from a plurality of different domains into one convenient location. Further, each of a plurality services are all concurrently available, the user enters an access datum (e.g., a search query) into field 205 and actuates a desired service by selecting one of buttons 210.

In the preferred embodiment, interface 200 relies on the user to establish a “context” for the datum in field 205. In some implementations, interface 200 includes a context resolver (e.g., artificial intelligence, expert system, heuristic, or other decision/analysis logic) to determine a context and to identify the appropriate service in response to a single search actuation, the context identified by the datum and the available services. In field 205, for example, a number such as 5,000,000 would trigger the patent search, a number like 10/500,000 would trigger an application search, a number like 101 would trigger a search of 35 U.S.C, and a datum like “Smith” would trigger a roster search. In some cases, the user datum may include a service identifier or service command concatenated (either pre-pended or post-pended for example) to resolve ambiguities or to select a particular service (e.g., “˜pat_app#” may be a directive to interface 200 to use the patent application service and pass the # to the service. The service command may include service access, control, password or other directive/control/informational parameter.

In this configuration, the searching may be command line driven for users desiring such functionality. A user would be able to access any service from field 205 by supplying the appropriate information.

Of course, the “datum” in field 205 may be variable length and support Boolean operators or other processors appropriate to the service. In some cases, interface 200 may preprocess the user datum (or provide additional default values) appropriate for a service or as specified by the user or the service. Some additional features of these pre-processing directives are described below in the preferences discussion. In some cases, the search result may be a document, or it may initiate some other process. For example, the service may initiate a particular buying service, such as search/purchase a book at Amazon.com, or from an other online merchant.

In the example given above, the services reflect a “Patent Theme” for interface 200. Service buttons 210 are configured to provide a user, perhaps a patent practitioner, with network resources that may be commonly and frequently used in her practice. It is easy to imagine other collections of themes for interface 200. A stock/financial theme having service buttons 210 for stock symbol lookup, stock price, company news, Edgar database, and other investment services.

Theme/update button 215 provides the user with a user-selectable list of available themes. The list is, in the preferred embodiment, a drop-down list that includes the preset themes currently available. By selecting a particular theme from button 215, service buttons 210 are configured by interface 200. In addition to identification of currently available themes, theme/update button 215 of the preferred embodiment includes an update item. This feature enables the user to update particular services or download additional themes from a theme server.

In an alternate preferred embodiment of the present invention, a user has alternate ways to update available themes or particular services of a theme. (It is understood that some services may be shared among several themes, either from the themes themselves, or through preferences/options.) Some of these ways include automatic updating by the resource when accessed using interface 200. Interface 200 and the resource (e.g., a webpage) may exchange configuration information and interface 200 would respond by either notifying the user that an update is available or that an update was made, or silently update the service (as determined by the user.) This configuration information may be available as meta-information, code, instruction or other directive (or user-accessible information in some implementations) that interface 200 recognizes as configuration information and permanently update interface 200. The update may either be a permanent addition of a new service, permanent modification to an existing service, or a new theme.

In an alternate preferred embodiment, interface 200 supports “dynamic themes” when enabled by a user. In this mode, interface 200 adapts to web pages encountered in the ordinary course of the user's activities. The dynamic configuration may be express (such as by the inclusion of meta-information in a particular web-page) or passive due to interface 200 recognizing/responding to the web page (e.g., content, meta-tags, domain name, domain type, domain extension (e.g., .com, .gov., .edu). Search engines are able to search for such configurator (dynamic or static) and return results to a user. As a short cut, the search engines may “push” service configuration to users.

Interface 200 configures service buttons 210 based upon the number of services in a particular theme, the number of service buttons 210 available for configuration, and other preferences/options associated with interface 200 or one or more services. For example, a particular theme may have six available services. Interface 200 may have a total of five service buttons 210, but the user may have identified that of these five, four are available for theme configuration.

Interface 200 optionally provides for services to be associated with particular service buttons 210 in an order determined by the theme provider, or, in an alternate preferred embodiment, each service button 210 includes a drop down list of the currently available services associated with the selected theme. The user selects which service to assign to which button 210 and which service to leave unassigned. The user may reconfigure any service button 210 with currently available options.

User preferences/options button 220 is available for the user to select available options associated with interface 200. Options may include simple interface 200 configuration options, such as a number of service buttons 210 to make available, which service buttons 210 are configurable (automatic or manually) by selecting a theme, whether any service buttons 210 are reserved/assigned for favorites or “intelligent configuration” or other service not expressly included in an available theme.

In this “intelligent mode” for interface 200, buttons 210 and themes may be added by accessing a special website/web page identifying one or more new buttons/themes. In another preferred embodiment, updates and theme addition services are available by subscription/payment to enhance functionality by adding new themes/buttons/features.

Search Engines

In the subscription/payment mode, a user has an account and stores account access information for the update service using preferences/options button 220. When checking for updates/new themes, interface 200 sends the account information to the update service for validation. A successful validation lets the user update/obtain new themes (some of which may have an associated fee).

Additionally, some services may require configuration/user information (e.g., login/passwords). While some services use various data persistent data elements (e.g., browser “cookies”), others require a login for use. Interface 200 may include user options associated with such themes to provide the login/password or other access information. Further, some services may be made directly available from interface 200 that would not otherwise be available.

In some services, there may be multiple query/service access options and fields that could access data entry. Interface 200 includes several different options for addressing these situations. In a simplest case, the user actuates a multi-entry service by selecting the corresponding service button 210 without any service data in field 205 (though service directives may be entered). Interface 200 thereafter provides the user with a multi-entry system, either native to interface 200 or opens the standard resource interface page.

Another option interface 200 provides includes use of delimiters in field 105 that the user inserts to separate the individual entries. For example, a tab-character or an infrequently used character (e.g., “˜”) or set of characters could be used. A user may enter “Company˜Name” into a “Detailed Search” service and interface 200 would parse the data entry and provide “Company” for as an assignee search and “Name” as an inventor search. Interface 200 assigns, in this example, data in variable order. A user inserts null data into a field by duplicating the delimiter. For example, a service accepts up to three variables: v1, v2, and v3. Submitting all three would be: data_{—}1˜data_{—}2˜data_{—}3. However, a user wishing to enter data for v1 and v3 without v2 would enter data_{—}1˜˜data_{—}3.

A further option, for services that have multi-field entry and the user provides less than a complete set of parameters for all the fields, interface 200 optionally stores default variables to add to the contents of field 205 when such a service button is actuated.

As an aid to the user for multi-field entry, a “tool tip” help pop-up may be provided to identify for the user the variable order. That is, hovering a cursor over a multi-field entry service, a tool tip advises the user that data may be entered in PatNo, Assignee, Inventor order, for example. An inventor name search would therefore become: ˜˜Name. When variable order runs from most commonly used to least commonly used fields, interface 200 offers the user a particularly efficient tool. Interface fills unidentified variable fields when parsing with nulls or default values as specified by the preferences/options. In some implementations, interface 200 provides the user with an ability to change the variable order, in addition to adding theme-field-specific default values. That is, for theme one, v2 may default to a first value while for theme two, v2 defaults to a second value different from the first.

An additional navigation ability offered by interface 200 is meta-data navigation. In meta-data navigation, certain resources/webpages are identified by a label or tag and accessed via these labels/tags rather than the content of the resource. For example, various resources in a domain may be identified as “home” “database access” “contact info” or any other feature. Entering an appropriate meta-label into field 205 and actuating service button 210, the user is navigated to the particular resource/webpage.

Toolbar 300 illustrates additional service buttons 210 to those shown in FIG. 2. Specifically, a Favorite_{—}1 and an ALL service button 210. (Interface 200 is configurable to include these option buttons as well.) The user configures toolbar 300 to define a particular number of service buttons 210, and how many of these buttons are automatically configurable by a theme selection using theme/update button 215. For toolbar 300, two buttons are special purpose buttons, the Favorite_{—}1 and the ALL service button.

Favorites permit the user to “lock” a service button 210 to a particular service and have it available across themes and any dynamic or intelligent configurations. Similarly, the ALL service button 210, initiates services from a plurality of the buttons 210 (specific ones depending upon the user's options/preferences) when it is actuated. In the preferred embodiment, toolbar 300 actuates each service independently as if it had been initiated by itself. However, in some implementations, toolbar 300 performs post-processing on the service conclusion (e.g., merge results or send all results to a printer).

Display 170 presents interface 200 and a pointer (e.g., a cursor) controlled by one or more I/O devices. CPU 105, executing instructions received from memory, renders interface 200 on display 170 and monitors the cursor's location when certain signals are sent from an I/O. When the cursor's position corresponds with one of the actuable features of interface 200, CPU 105 implements additional instructions appropriate for the particular feature (e.g., a particular button 210). The additional instructions implement the system and method described above for the manufacture and using of the preferred embodiment for interface 200.

Although embodiments of the invention have been described primarily with respect to a initiating searches using queries to search/server applets implemented using familiar URLs for identifiers, many types of resource retrieval (e.g., targeted document retrieval, etc.) may benefit from features of the invention. Other query/resource access products such as those contemplated for semantic web identifier access, etc., may similarly benefit from features of the invention.

The system, method, computer program product, and propagated signal described in this application may, of course, be embodied in hardware; e.g., within or coupled to a Central Processing Unit (“CPU”), microprocessor, microcontroller, System on Chip (“SOC”), or any other programmable device. Additionally, the system, method, computer program product, and propagated signal may be embodied in software (e.g., computer readable code, program code, instructions and/or data disposed in any form, such as source, object or machine language) disposed, for example, in a computer usable (e.g., readable) medium configured to store the software. Such software enables the function, fabrication, modeling, simulation, description and/or testing of the apparatus and processes described herein. For example, this can be accomplished through the use of general programming languages (e.g., C, C++), GDSII databases, hardware description languages (HDL) including Verilog HDL, VHDL, AHDL (Altera HDL) and so on, or other available programs, databases, nanoprocessing, and/or circuit (i.e., schematic) capture tools. Such software can be disposed in any known computer usable medium including semiconductor, magnetic disk, optical disc (e.g., CD-ROM, DVD-ROM, etc.) and as a computer data signal embodied in a computer usable (e.g., readable) transmission medium (e.g., carrier wave or any other medium including digital, optical, or analog-based medium). As such, the software can be transmitted over communication networks including the Internet and intranets. A system, method, computer program product, and propagated signal embodied in software may be included in a semiconductor intellectual property core (e.g., embodied in HDL) and transformed to hardware in the production of integrated circuits. Additionally, a system, method, computer program product, and propagated signal as described herein may be embodied as a combination of hardware and software.

One of the preferred implementations of the present invention is as a routine in an operating system made up of programming steps or instructions resident in a memory of a computing system shown in FIG. 2, during computer operations. Until required by the computer system, the program instructions may be stored in another readable medium, e.g. in a disk drive, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Internet, when required by the user of the present invention. One skilled in the art should appreciate that the processes controlling the present invention are capable of being distributed in the form of computer readable media in a variety of forms.

Any suitable programming language can be used to implement the routines of the present invention including C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

Thus, the scope of the invention is to be determined solely by the appended claims.

1. An apparatus for generating a query to a particular one of a plurality of queryable network processes, the apparatus comprising:
a query assembly system communicable to a network supporting the queryable network processes, the query assembly system including:
a first memory; and
first control logic, configured to produce, in response to a first set of instructions in the first memory and to an input from a user, the query to the particular one of the plurality of queryable network processes, the particular one query derived from a content of a data field according to a particular one of a plurality of concurrently displayed query actuating controls of an interface element actuated by the input, with each of the query actuating controls associated with a different one of the plurality of queryable network processes and the particular one queryable network process associated with the particular one query actuating control; and
a query communications system, communicable to a network supporting the queryable network processes, the query communications system including:
a second memory; and
second control logic, configured to communicate, in response to a second set of instructions in the second memory and to production of the query by the query assembly system, the query to the particular one queryable network process.

2. The apparatus of claim 1 wherein the first memory and the second memory are included in a memory system.

3. The apparatus of claim 1 wherein the interface element is a toolbar for an application.

4. The apparatus of claim 1 wherein the interface element includes a theme control for substantially concurrently changing a plurality of associations of the query actuating controls relative to a second plurality of queryable network processes.

5. The apparatus of claim 1 wherein the content includes a search query, and actuation of the particular one actuable control communicates the search query to the queryable network process associated with the particular one actuable control.

6. The apparatus of claim 5 wherein:
the search query includes multiple search terms for multiple keys of the queryable network process;
the particular one actuable control parses the search query into a plurality of individual search terms; and
the query communications system corresponds the plurality of individual search terms with appropriate individual keys of the queryable network process.

7. The apparatus of claim 1 wherein the queryable network processes are different configurations of a search applet.

8. The apparatus of claim 1 wherein at least two of the queryable network processes are accessed from two different network domains.

9. An apparatus for generating a query to a particular one of a plurality of queryable network processes, the apparatus comprising:
a query assembly system communicable to a network supporting the queryable network processes, the query assembly system including:
a first memory; and
first control logic, configured to produce, in response to a first set of instructions in the first memory and to an input from a user, the query to the particular one of the plurality of queryable network processes, the particular one query derived from a content of a data field according to a heuristic evaluation of the content in response to actuation of a query actuating control of an interface element actuated by the input, with the query actuating control associated with a different one of the plurality of queryable network processes depending upon the evaluation; and
a query communications system, communicable to a network supporting the queryable network processes, the query communications system including:
a second memory; and
second control logic, configured to communicate, in response to a second set of instructions in the second memory and to production of the query by the query assembly system, the query to the particular one queryable network process.

10. The apparatus of claim 9 wherein the heuristic evaluation is influenced by a theme selected for the interface element.

11. A method for generating a query to a particular one of a plurality of queryable network processes, the method comprising:
producing the query from a content of a user-enterable data field of an interface element in response to an actuation of one of a plurality of concurrently presented controls of the interface, each the control having an association with a different one of the plurality of queryable network processes; and
communicating the query to the particular one queryable network process.

12. The method of claim 11 wherein the content includes a search query, and the actuation communicates the search query to the queryable network process associated with the particular one actuable control.

13. The method of claim 12 wherein:
the search query includes multiple search terms for multiple keys of the queryable network process;
the particular one actuable control parses the search query into a plurality of individual search terms; and
the communicating step corresponds the plurality of individual search terms with appropriate individual keys of the queryable network process.

14. The method of claim 11 further comprising:
modifying the association of a plurality of the controls responsive to an association change signal

15. The method of claim 14 wherein the association change signal is a theme change signal.

16. The method of claim 14 wherein the association change signal is an update change signal.

17. The method of claim 14 wherein the interface element is associated with a network access process and the association changes dynamically responsive to resources accessed by the network access process.

18. A method for generating a query to a particular one of a plurality of queryable network processes, the method comprising:
producing heuristically the query from a content of a user-enterable data field of an interface element in response to an actuation of a control of the interface element; and
communicating the query to the particular one queryable network process.

19. The method of claim 18 wherein the producing step is responsive to a theme associated with the interface element.

20. A computer program product comprising a computer readable medium carrying program instructions for generating a query to a particular one of a plurality of queryable network processes when executed using a computing system, the executed program instructions executing a method, the method comprising:
producing the query from a content of a user-enterable data field of an interface element in response to an actuation of one of a plurality of concurrently presented controls of the interface, each the control having an association with a different one of the plurality of queryable network processes; and
communicating the query to the particular one queryable network process.

21. The computer program product of claim 20 wherein the content includes a search query, and the actuation communicates the search query to the queryable network process associated with the particular one actuable control.

22. The computer program product of claim 21 wherein:
the search query includes multiple search terms for multiple keys of the queryable network process;
the particular one actuable control parses the search query into a plurality of individual search terms; and
the communicating step corresponds the plurality of individual search terms with appropriate individual keys of the queryable network process.

23. The computer program product of claim 20 further comprising:
modifying the association of a plurality of the controls responsive to an association change signal.

24. The computer program product of claim 23 wherein the association change signal is a theme change signal.

25. The method of claim 23 wherein the association change signal is an update change signal.

26. The method of claim 23 wherein the interface element is associated with a network access process and the association changes dynamically responsive to resources accessed by the network access process.

27. A computer program product comprising a computer readable medium carrying program instructions for generating a query to a particular one of a plurality of queryable network processes when executed using a computing system, the executed program instructions executing a method, the method comprising:
producing heuristically the query from a content of a user-enterable data field of an interface element in response to an actuation of a control of the interface element; and
communicating the query to the particular one queryable network process.

28. The invention as substantially described herein.
